(19) United States
(12) Patent Application Publication
(10) Pub. No.: US 2008/0117928 A1
(43) Pub. Date: May 22, 2008

(54) Communication capture in a geo-spatial environment

(75) Inventor: Raj Vasant Abhyanker, Cupertino, CA (US)

Correspondence Address: PILLSBURY WINTHROP SHAW PITTMAN LLP, P.O. BOX 10500, MCLEAN, VA, 22102, US

(73) Assignee: Fatdoor, Inc.

(21) Appl. No.: 11/823,369

(22) Filed: Jun. 26, 2007

Related U.S. Application Data
(63) Continuation-in-part of application No. 11/603,442, filed on Nov. 22, 2006.

(51) Int. Cl. H04L 12/28; G05B 23/02

(52) U.S. Cl. 370/431; 340/3.3; 709/227

(57) ABSTRACT

A method, system and apparatus of communication capture in a geo-spatial environment are disclosed. In one embodiment, a method includes providing a plurality of user profiles, each user profile to include a specific contact code, associating a first user with a first user profile in the plurality of user profiles, selecting a second user profile in the plurality of user profiles, selecting a communication indicator associated with the second user profile, generating a communication between a first communication device and a second communication device based on the specific contact code associated with the second user profile, and archiving the communication.

### CLAIM OF PRIORITY

This application is a continuation in part and claims priority from U.S. Non-Provisional patent application Ser. No. 11/603,442, titled “Map Based Neighborhood Search and Community Contribution” filed on Nov. 22, 2006.

### FIELD OF TECHNOLOGY

This disclosure relates generally to the technical fields of communications hardware and/or software, and in one embodiment, to a method, system and apparatus of communication capture in a geo-spatial environment.

### BACKGROUND

Telephonic and Voice-Over-IP (VOIP) communications may facilitate communication between parties. A person may place a call via a telephone, a mobile phone, a computer and/or other device. Sometimes, the person may wish to place the call, but may not have correct contact information. To obtain the correct contact information, the person may search multiple resources. For example, the person may search directory websites, businesses' web pages, telephone directory books, and/or address books.

In an effort to avoid repetitive searches for the same contact information, the person may invest time and effort inputting contact information into a repository such as a contact list on a website and/or the mobile phone. The person may input information of multiple parties to build a comprehensive contact list.

Once parties have communicated, the parties may be unable to capture, revisit and/or otherwise use the content of the call and/or communication. For example, the person may be unable to reference a memorialized conversation. Parties to the call may be unable to share the contact of the call after the fact. The parties may be unable to disseminate the content of the call to a wider audience.

Conversely, various individuals, groups, businesses, media conglomerates, and so forth may have an interest in and may seek the content of others' communications, yet may not have access to the content.

### SUMMARY OF THE DISCLOSURE

A method, apparatus and system of communication capture in a geo-spatial environment are disclosed. In one aspect, a method includes providing a plurality of user profiles, each user profile to include a specific contact code, associating a first user with a first user profile, selecting a second user profile, selecting a communication indicator associated with the second user profile, generating a communication (e.g., an interview between the first user and the second user conducted through a geo-spatial social network embodying the three-dimensional map view) between a first communication device and a second communication device based on the specific contact code associated with the second user profile, and archiving the communication.

The method may further include providing access to the archived communication, representing the communication as a marker in a three-dimensional map view, simultaneously representing other user profiles adjacent to the marker, and placing the marker in a location associated with the first user and/or the second user. In addition, the method may include generating a webpage associated with the archived communication. The method may also include generating at least one wiki profile associated with the webpage. The method may further include generating a commerce transaction associated with the archived communication.

The method may include distributing the archived communication according to a predetermined distribution plan. The method may also include distributing the archived communication to media providers. The method may also include providing the archived communication via a fixed medium.

In another aspect, a system includes an integrated social-communication environment, a contact module of the integrated social-communication environment, to include user profiles, each user profile to include a specific contact code, a select module to select a user profile, a communication module to generate a communication (e.g., based on the specific contact code of the selected user profile) between a first communication device and a second communication device, and an archive module to archive the communication.

The system may further include a publish module to publish the archived communication. The system may include a webpage module to generate a webpage associated with the archived communication. The system may include a wiki profile module to generate, with the webpage, at least one wiki profile associated with the webpage. The system may also include an append module to generate, with the wiki profile, content associated with the wiki profile. The system may include a distribution module to distribute the archived communication via a distribution channel.

Furthermore, the system may include a media module to distribute the archived communication to media providers. The system may also include a commerce transaction module to generate a transaction associated with the archived communication. The system may include a fee-based transaction module to generate a fee-based transaction associated with the archived communication. The system may also include a download module to provide the system on a communication device.

In yet another aspect, an integrated social-communication environment includes a first instruction set to enable a social network, to include a user database, the user database to include associated user profiles, the social network associated with contact data, in which the social network is associated with specific contact codes in the contact data, a second instruction set integrated with the first instruction set to select a user profile, the user profile to include a specific contact code identifiable in the contact data, a third instruction set integrated with the first instruction set and the second instruction set to generate a communication, between a first communication device associated with a first user profile and a second communication device associated with a selected second user profile, the communication path based on the specific contact code associated with the selected user profile, and a fourth instruction set integrated with the first instruction set and the second instruction set and the third instruction set to archive the communication.

The integrated social-communication environment may further include a fifth instruction set to provide accessibility to the archived communication. The integrated social-communication environment may also include a sixth instruction set to distribute the archived communication.

In a further aspect, a system includes a first communication device (e.g., a personal computer, a mobile phone, and/or a personal digital assistant) including a contact module of an integrated social-communication environment, to include user profiles, each user profile to include an associated specific contact code, a select module to select a user profile, a communication module, to generate a communication, between the first communication device and a second communication device associated with a selected user profile, and an archive module to archive the communication. The system may further include a display page (e.g., a webpage) associated with the archived communication. The system may include at least one wiki profile associated with the display page. In addition, the system may include content appended to the wiki profile.

The method, systems, and apparatus disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of an integrated social-communication environment communicating with users through a network, according to one embodiment.

FIG. 2 is an exploded view of the social network module of FIG. 1, according to one embodiment.

FIG. 3 is an exploded view of the additional modules of FIG. 1, according to one embodiment.

FIG. 4 is a schematic representation of a first communication device communicating with a second communication device through the network, according to one embodiment.

FIG. 5 is a schematic representation of archiving a communication between the first communication device and the second communication device, according to one embodiment.

FIG. 6 is a schematic representation of distributing the archived communication in the integrated social-communication environment, according to one embodiment.

FIG. 7 is a user interface view of a first user profile associated with a first user in the integrated social-communication environment, according to one embodiment.

FIG. 8 is an archive option page view showing archive options associated with the archived communication, according to one embodiment.

FIG. 9 is a user interface view of a schedule distribution page, according to one embodiment.

FIG. 10 is a user interface view of a communication device illustrating a display page, according to one embodiment.

FIG. 11 is a table view displaying distribution details of the archived communication, according to one embodiment.

FIG. 12 is a diagrammatic system view of a data processing system in which any of the embodiments disclosed herein may be performed, according to one embodiment.

FIG. 13A is a process flow of generating and archiving a communication between a first communication device and a second communication device, according to one embodiment.

FIG. 13B is a continuation of the process flow of FIG. 13A, showing additional processes, according to one embodiment.

FIG. 13C is a continuation of the process flow of FIG. 13B, showing additional processes, according to one embodiment.

Other features of the present embodiments will be apparent from the accompanying drawings and from the detailed description that follows.

### DETAILED DESCRIPTION

A method, system and apparatus of communication capture in a geo-spatial environment are disclosed. In the following description, for the purposes of explanation, numerous specific details are set forth in order to provide a thorough understanding of the various embodiments. It will be evident, however, to one skilled in the art that the various embodiments may be practiced without these specific details.

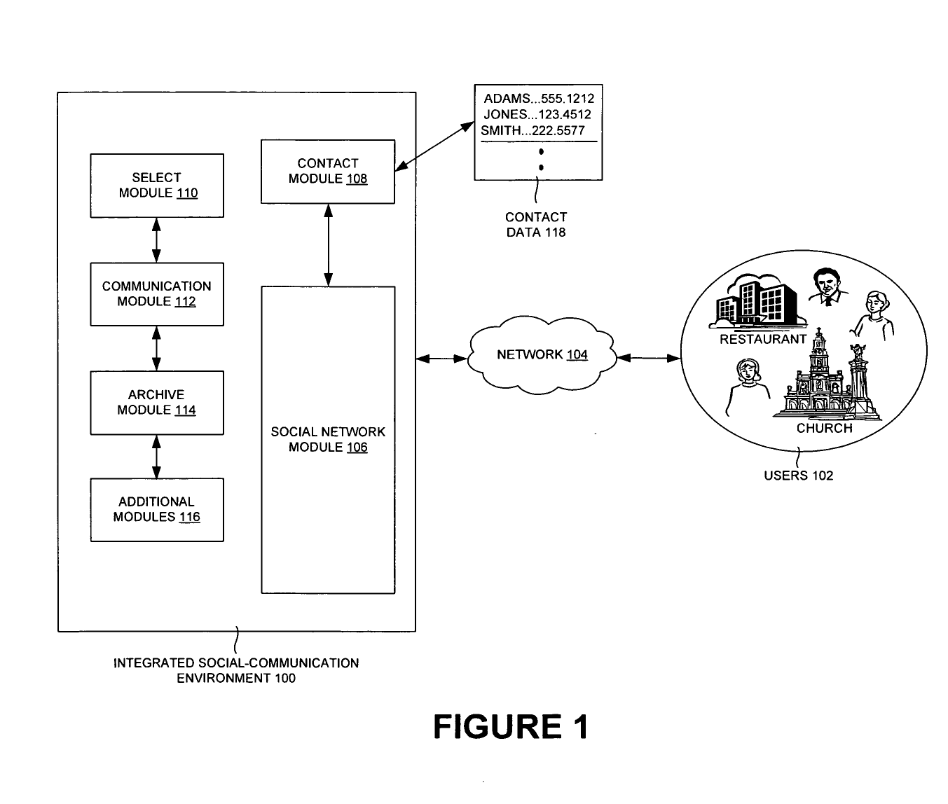

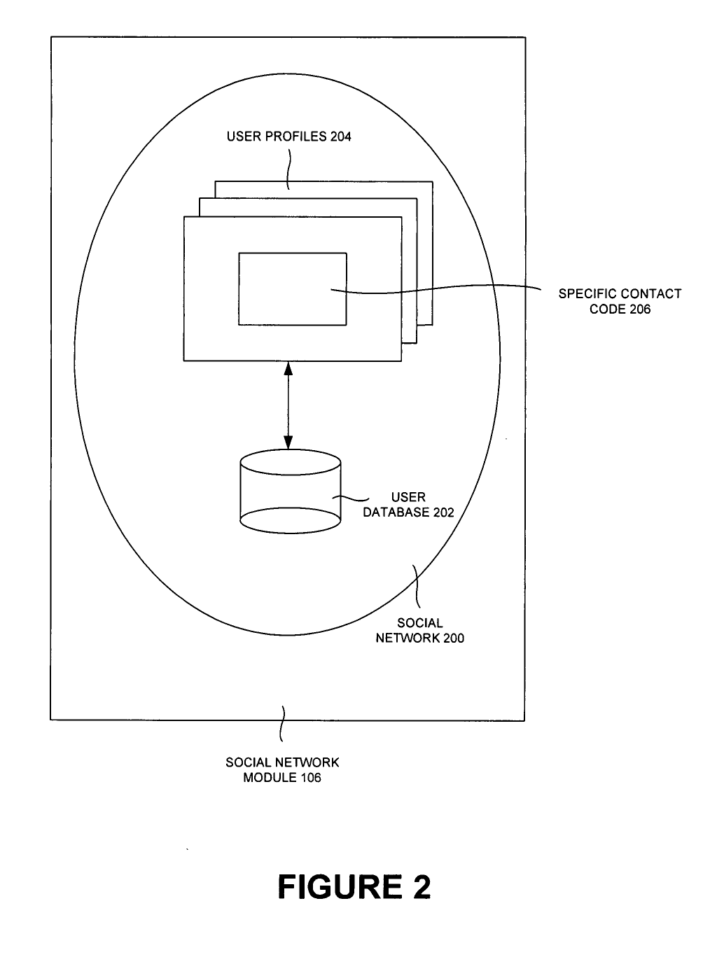

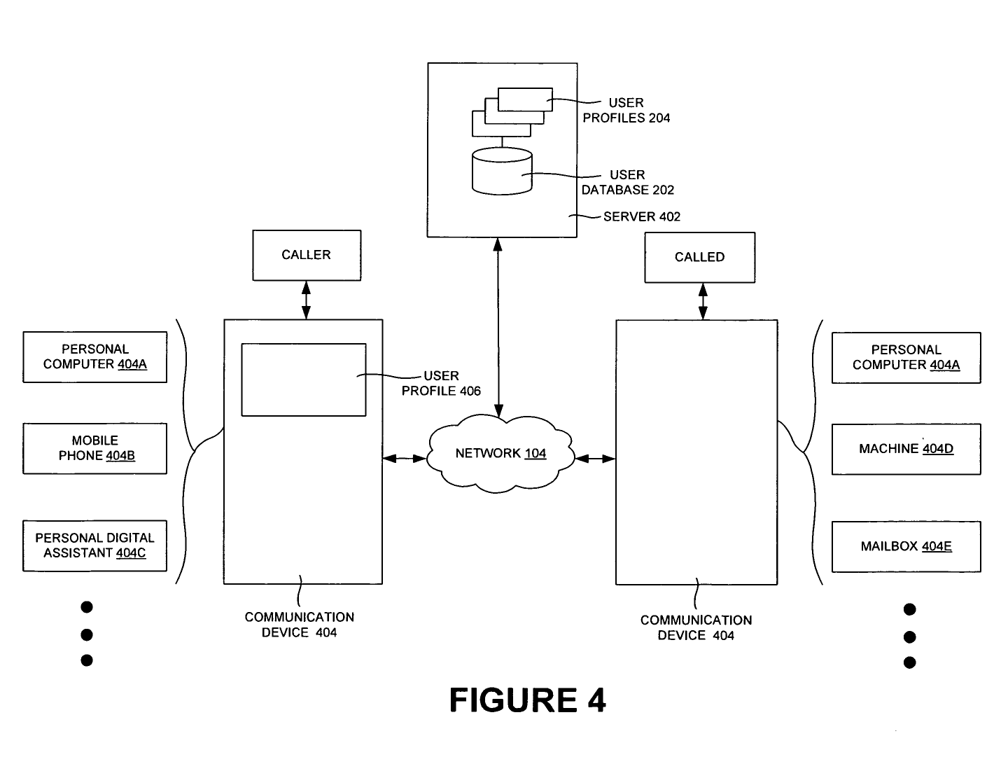

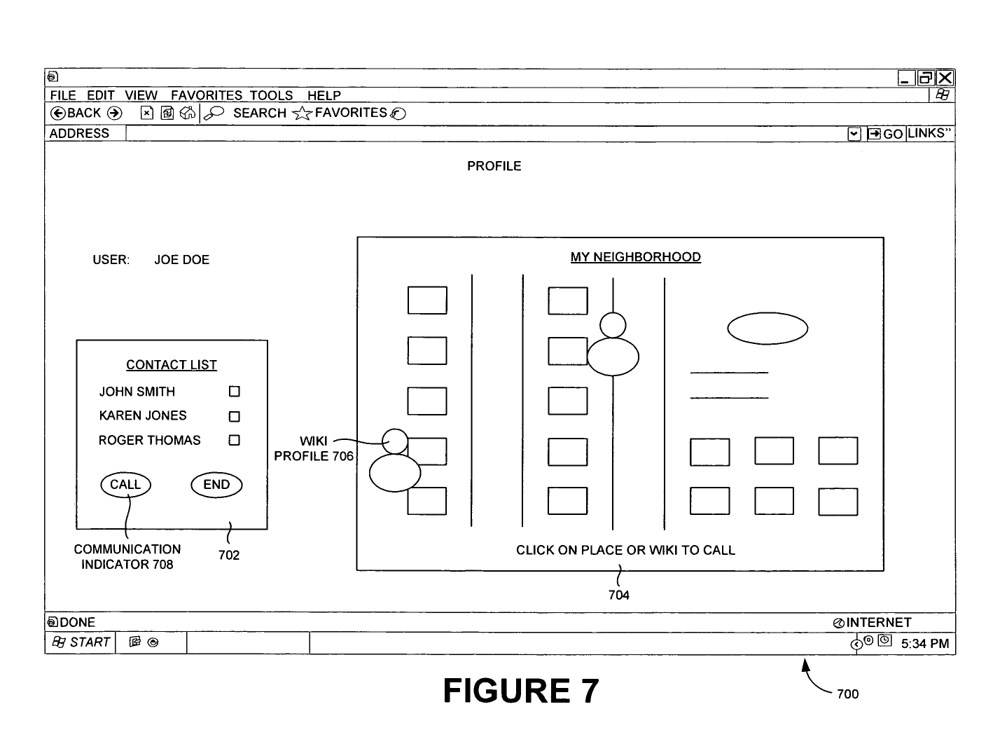

In one embodiment, a method includes providing a plurality of user profiles (e.g., the user profiles 204 of FIG. 2 associated with the users 102 of FIG. 1), each user profile to include a specific contact code (e.g., the specific contact code 206 of FIG. 2), associating a first user 102 with a first user profile 204, selecting a second user profile 204, selecting a communication indicator (e.g., the communication indicator 708 of FIG. 7) associated with the second user profile 204, generating a communication between a first communication device (e.g., the communication device 404 of FIG. 4) and a second communication device 404 based on the specific contact code 206 associated with the second user profile 204, and archiving the communication (e.g., using the archive module 114 of FIG. 1).

In another embodiment, a system includes an integrated social-communication environment (e.g., the integrated social-communication environment 100 of FIG. 1), a contact module (e.g., the contact module 108 of FIG. 1) of the integrated social-communication environment 100, to include user profiles (e.g., the user profiles 204 of FIG. 2), each user profile 204 to include a specific contact code, a select module (e.g., the select module 110 of FIG. 1) to select a user profile 204, a communication module (e.g., the communication module 112 of FIG. 1) to generate a communication (e.g., based on the specific contact code 206 of the selected user profile of the user profiles 204) between a first communication device 404 and a second communication device 404, and an archive module (e.g., the archive module 114 of FIG. 1) to archive the communication.

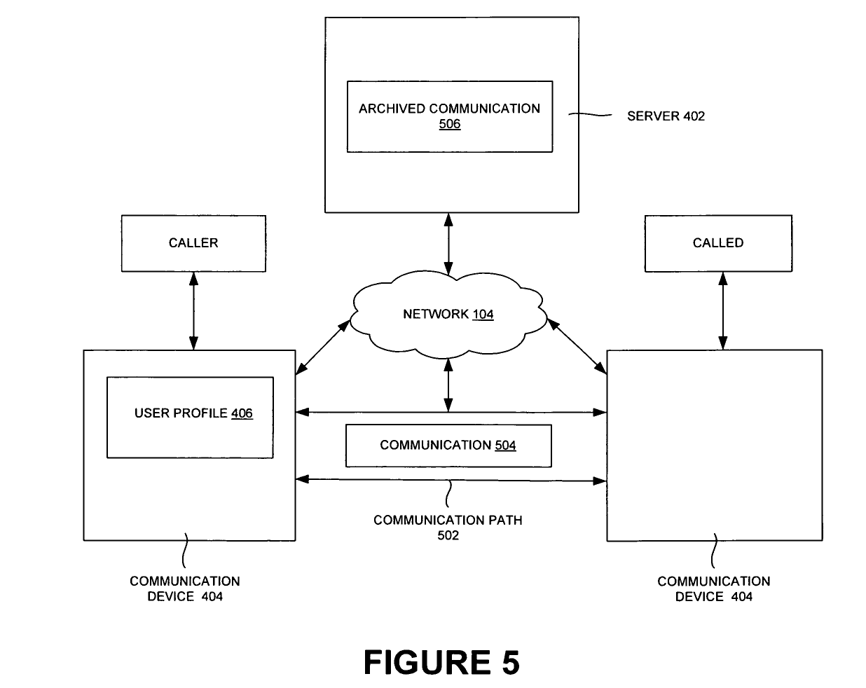

In yet another embodiment, an integrated social-communication environment (e.g., the integrated social-communication environment 100 of FIG. 1) includes a first instruction set to enable a social network (e.g., the social network 200 of FIG. 2) to include a user database (e.g., the user database 202 of FIG. 2), the user database to include associated user profiles 204, the social network 200 associated with contact data (e.g., the contact data 118 of FIG. 1), in which the social network 200 is associated with specific contact codes in the contact data 118, a second instruction set integrated with the first instruction set to select a user profile 204, the user profile 204 to include a specific contact code 206 identifiable in the contact data 118, a third instruction set integrated with the first instruction set and the second instruction set to generate a communication (e.g., the communication 504 of FIG. 5), between a first communication device 404 associated with a first user profile 204 and a second communication device 404 associated with a selected second user profile 204, the communication path (e.g., the communication path 502 of FIG. 5) based on the specific contact code 206 associated with the selected user profile 204, and a fourth instruction set integrated with the first instruction set and the second instruction set and the third instruction set to archive the communication.

In a further embodiment, a system includes a first communication device 404 (e.g., a personal computer, a mobile phone, a personal digital assistant, etc.) including a contact module (e.g., the contact module 108 of FIG. 1) of the integrated social-communication environment 100, to include user profiles 204, each user profile 204 to include an associated specific contact code 206, a select module (e.g., the select module 110 of FIG. 1) to select a user profile 204, a communication module (e.g., the communication module 112 of FIG. 1), to generate a communication, between the first communication device 404 and a second communication device 404 associated with a selected user profile 204, and an archive module (e.g., the archive module 114 of FIG. 1) to archive the communication.

FIG. 1 is a system view of an integrated social-communication environment 100 communicating with users 102 through a network 104, according to one embodiment. Particularly, FIG. 1 illustrates the integrated social-communication environment 100, the users 102, the network 104, a social network module 106, a contact module 108, a select module 110, a communication module 112, an archive module 114, additional modules 116 and contact data 118, according to one embodiment.

The integrated social-communication environment 100 may enable generation of communication (e.g., the communication 504 of FIG. 5) between a first user 102 associated with a first user profile 204 and a second user 102 associated with a second user profile 204 based on a specific contact code 206 associated with the second user profile 204 in a geo-spatial social network (e.g., in a geo-spatial environment). In addition, the integrated social-communication environment 100 may enable archiving the communication between the first user 102 and the second user 102 and distribution of the archived communication (e.g., the archived communication 506 of FIG. 5) to various entities such as media providers, golf buddies, public radio stations, parents, work buddies, etc. in the geo-spatial social network according to a pre-determined distribution plan.

The users 102 may be entities (e.g., a person, a church, a business, etc.) associated with user profiles (e.g., the user profiles 204 of FIG. 2) involved in the communication with other users 102 in the geo-spatial social network (e.g., the social network 200 of FIG. 2). The network 104 may facilitate the communication 504 between the integrated social-communication environment 100 and the users 102 associated with the user profiles 204. The social network module 106 may enable social networking between the users 102 of the geo-spatial environment. The contact module 108 may display contact lists associated with the users 102 of the integrated social-communication environment 100.

The select module 110 may enable selection of the second user 102 associated with the second user profile 204 to generate the communication 504 between the first user 102 and the second user 102 based on the specific contact code 206 of the second user profile 204 in the integrated social-communication environment 100. The communication module 112 may generate the communication 504 between a first communication device 404 and a second communication device 404 on accessing the specific contact code 206 associated with the second user profile 204 in the geo-spatial environment (e.g., the social network 200 of FIG. 2).

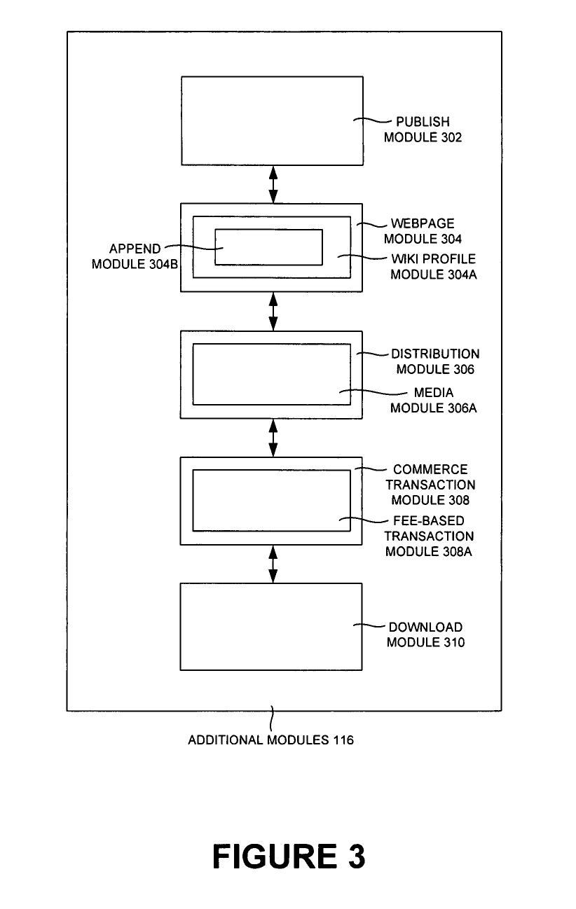

The archive module 114 may enable archiving the communication 504 and provide access to the archived communication 506 between the users 102 of the integrated social-communication environment 100. The additional modules 116 may include various other modules (e.g., the publish module 302, the webpage module 304, the wiki profile module 304A, the append module 304B, the distribution module 306, the media module 306A, the commerce transaction module 308, the fee-based transaction module 308A, the download module 310 of FIG. 3) associated with the user profiles 204. The contact data 118 may be address data and/or location data associated with the users 102 of the geo-spatial social network 200 having the user profiles 204 with the specific codes for communication.

In the example embodiment illustrated in FIG. 1, the integrated social-communication environment 100 communicates with the users 102 through the network 104. The integrated social-communication environment 100 includes the social network module 106, the contact module 108, the select module 110, the communication module 112, the archive module 114 and the additional modules 116, communicating with each other.

The first user 102 may be associated with the first user profile 204. The second user profile 204 may also be selected (e.g., using the select module 110 of FIG. 1). The contact module 108 of the integrated social-communication environment 100 may include the user profiles 204, each user profile 204 to include a specific contact code (e.g., the specific contact code 206 of FIG. 2). The select module 110 may select a user profile 204 (e.g., the second user profile 204). The communication module 112 may generate the communication 504 (e.g., based on the specific contact code 206 of the selected user profile 204) between the first communication device 404 and the second communication device 404. The archive module 114 may archive the communication 504.

FIG. 2 is an exploded view of the social network module 106 of FIG. 1, according to one embodiment. Particularly, FIG. 2 illustrates a social network 200, a user database 202, user profiles 204 and a specific contact code 206, according to one embodiment.

The social network 200 may be a social-communication network that enables the networking between the users 102 of the integrated social-communication environment 100 (e.g., in a geo-spatial environment). The user database 202 may contain the user profiles 204 associated with the users 102 in the geo-spatial social network 200. The user profiles 204 may be profiles generated from the user database 202 associated with the users 102 communicating in the integrated social-communication environment 100. The specific contact code 206 may be a code assigned to each user profile 204 and on which the communication 504 generated between the users 102 (e.g., the first user 102 and the second user 102) in the integrated social-communication environment 100 may be based.

In the example embodiment illustrated in FIG. 2, the social network module 106 includes the social network 200. The social network 200 consists of the user database 202, to include the user profiles 204 having the specific contact code 206.

The user profiles 204 may be provided, each user profile 204 to include the specific contact code 206. A first instruction set may enable the social network 200, which includes the user database 202, the user database 202 to include associated user profiles 204, the social network 200 associated with the contact data 118, in which the social network 200 is associated with specific contact codes 206 in the contact data 118. A second instruction set may integrate with the first instruction set to select a user profile 204, the user profile 204 to include the specific contact code 206 identifiable in the contact data 118.

FIG. 3 is an exploded view of the additional modules 116 of FIG. 1, according to one embodiment. Particularly, FIG. 3 illustrates a publish module 302, a webpage module 304, a wiki profile module 304A, an append module 304B, a distribution module 306, a media module 306A, a commerce transaction module 308, a fee-based transaction module 308A and a download module 310, according to one embodiment.

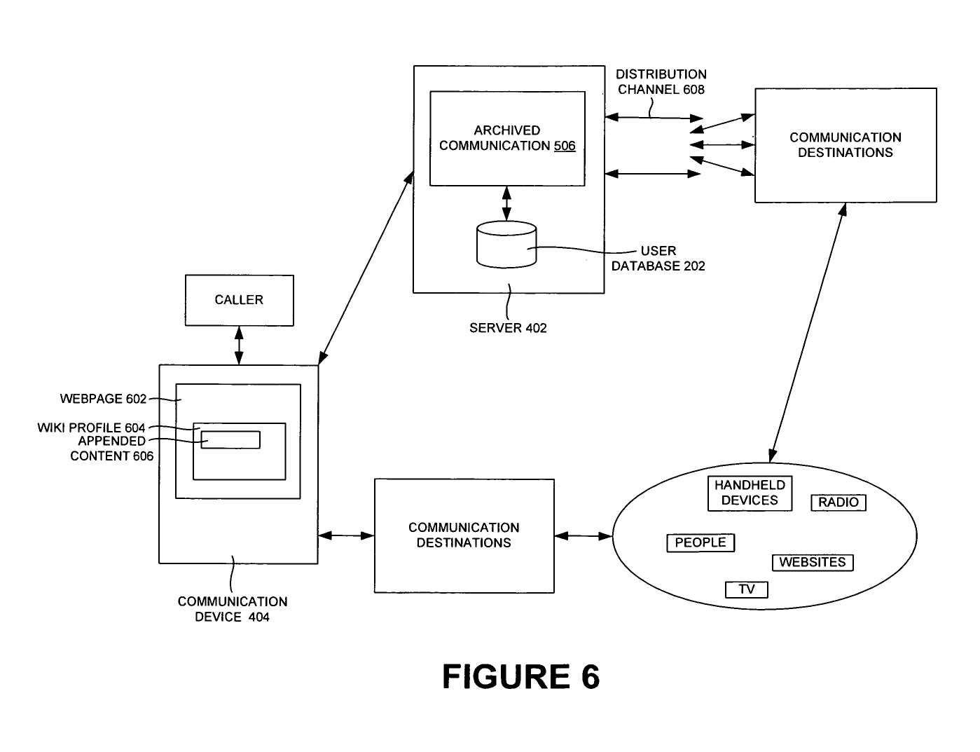

The publish module 302 may publish the archived communication 506 associated with the first user 102 and the second user 102 in the integrated social-communication environment 100. The webpage module 304 may generate a webpage (e.g., the webpage 602 of FIG. 6) associated with the archived communication 506 between the first communication device 404 and the second communication device 404 in the geo-spatial social network 200. The wiki profile module 304A may generate a wiki profile (e.g., the wiki profile 706 of FIG. 7) when the webpage 602 associated with the archived communication 506 is being generated. The append module 304B may generate a content associated with the wiki profile 706 during the generation of the wiki profile 706 associated with the webpage 602.

The distribution module 306 may enable distribution of the archived communication 506 associated with the first user 102 and the second user 102 according to the pre-determined distribution plan through various distribution channels (e.g., distribution channel 608 of FIG. 6). The media module 306A may distribute the archived communication 506 to media providers in a fixed medium (e.g., a compact disc (CD) and/or digital video disc (DVD)) in the integrated social-communication environment 100. The commerce transaction module 308 may generate a commercial transaction associated with the archived communication 506. The fee-based transaction module 308A may generate a fee-based transaction associated with the archived communication 506. The download module 310 may enable downloading communication system on a communication device (e.g., a personal computer, a mobile phone and/or a personal digital assistant) associated with the users 102 of the integrated social-communication environment 100.

In the example embodiment illustrated in FIG. 3, the additional modules 116 include the publish module 302, the webpage module 304, the wiki profile module 304A, the append module 304B, the distribution module 306, the media module 306A, the commerce transaction module 308, the fee-based transaction module 308A and the download module 310, communicating with each other.

The commerce transaction may be associated with the archived communication 506. The publish module 302 may publish the archived communication 506. The webpage module 304 may generate the webpage 602 associated with the archived communication 506. The wiki profile module 304A may generate, with the webpage 602, the wiki profile 706 associated with the webpage 602. The append module 304B may generate, with the wiki profile 706, content associated with the wiki profile 706. The distribution module 306 may distribute the archived communication 506 via a distribution channel 608.

The media module 306A may distribute the archived communication 506 to media providers. The commerce transaction module 308 may generate the transaction associated with the archived communication 506. The fee-based transaction module 308A may generate the fee-based transaction associated with the archived communication 506. The download module 310 may provide the communication system on the communication device 404.

FIG. 4 is a schematic representation of the first communication device 404 communicating with the second communication device 404 through the network 104, according to one embodiment. Particularly, FIG. 4 illustrates the network 104, the user database 202, the user profiles 204, a server 402, a communication device 404 and a user profile 406, according to one embodiment.

The server 402 may contain the user database 202 through which the user profiles 204 associated with the users 102 communicating in the integrated social-communication environment 100 are generated. The communication device 404 may be a personal computer, a mobile phone, and/or a personal digital assistant associated with the user(s) 102 (e.g., the first user 102, the second user 102) communicating in the integrated social-communication environment 100. The user profile 406 may provide details (e.g., name, address, contact lists, etc.) associated with the first user 102 communicating through the communication device 404 in the integrated social-communication environment 100.

In the example embodiment illustrated in FIG. 4, the communication device 404 (e.g., a personal computer 404A, a mobile phone 404B, and a personal digital assistant 404C) associated with a caller (e.g., the first user 102) communicates with the communication device 404 (e.g., a personal computer 404A, a machine 404D, and a mailbox 404E) associated with a called user 102 (e.g., the second user 102) based on a specific code 206 associated with the called user profile through the network 104. The communication device(s) 404 also communicate with the server 402 containing the user database 202.

The communication 504 may be generated between the first communication device (e.g., the personal computer 404A, the mobile phone 404B, and/or the personal digital assistant 404C) and the second communication device (e.g., the personal computer 404A, the machine 404D, and/or the mailbox 404E) based on the specific contact code 206 associated with the second user profile 204. The first communication device 404 may include the contact module 108 of the integrated social-communication environment 100, to include the user profiles 204, each user profile 204 to include an associated specific contact code (e.g., the specific contact code 206 of FIG. 2). The first communication device may also include the select module 110 to select a user profile 204. The communication module 112 of the first communication device 404 may generate the communication 504 between the first communication device 404 and the second communication device 404 associated with the selected user profile 204.

FIG. 5 is a schematic representation of archiving the communication between the first communication device 404 and the second communication device 404, according to one embodiment. Particularly, FIG. 5 illustrates the network 104, the server 402, the communication device 404 associated with the caller and the called user, the user profile 406, a communication path 502, a communication 504 and an archived communication 506, according to one embodiment.

The server 402 may archive the communication 504 generated between the first communication device 404 associated with the caller (e.g., the first user 102) and the second communication device 404 associated with the called user 102 (e.g., the second user 102) in the integrated social-communication environment 100. The communication device 404 associated with the caller and the called user 102 may be the personal computer, the mobile device, the personal digital assistant, etc. through which the communication 504 is generated in the integrated social-communication environment 100.

The communication path 502 may represent a path that connects the first communication device 404 with the second communication device 404 based on the specific contact code 206 of the selected user profile 204 (e.g., the second user profile 204) in the integrated social-communication environment 100. The communication 504 may be, for example, an interview, a discussion and/or a conversation generated between the first communication device 404 and the second communication device 404 based on the specific contact code 206 associated with the selected second user profile 204. The archived communication 506 may be a communication archived between the first communication device 404 and the second communication device 404 through the network 104 that is recorded in the server 402 using the archive module 114.

In the example embodiment illustrated in FIG. 5, the communication device(s) 404 communicates with the server 402 to archive the communication 504. The communication device(s) 404 communicate with each other using communication path 502.

The communication 504 (e.g., generated between the first communication device 404 and the second communication device 404) may be archived. A third instruction set may be integrated with the first instruction set and the second instruction set to generate the communication 504, between the first communication device 404 associated with the first user profile 204 and the second communication device 404 associated with the selected second user profile 204, the communication path 502 based on the specific contact code 206 associated with the selected user profile 204. A fourth instruction set may be integrated with the first instruction set and the second instruction set and the third instruction set to archive the communication 504. The archive module 114 of the first communication device 404 may also archive the communication 504.

FIG. 6 is a schematic representation of distributing the archived communication in the integrated social-communication environment 100, according to one embodiment. Particularly, FIG. 6 illustrates the user database 202, the server 402, the communication device 404 of the caller, the archived communication 506, a webpage 602, a wiki profile 604, an appended content 606 and a distribution channel 608, according to one embodiment.

The webpage 602 may be a webpage associated with the archived communication 506 generated (e.g., through the webpage module 304 of FIG. 3) in the communication device 404 of the caller (e.g., the first user 102). The wiki profile 604 may be a wiki profile associated with the caller, generated (e.g., using the wiki profile module 304A of FIG. 3) in the webpage 602 in the communication device 404. The appended content 606 may be comments, thoughts and/or views that are appended to the wiki profile 604 using the append module (e.g., the append module 304B of FIG. 3). The distribution channel 608 may display different modes through which the archived communication 506 is distributed according to the predetermined distribution plan.

In the example embodiment illustrated in FIG. 6, the webpage 602 generated in the communication device 404 displays the wiki profile 604 and the appended content 606. The schematic representation shows the distribution channel 608 through which the archived communication 506 stored in the server 402 is distributed to required communication destinations. The various communication sources include hand-held devices, radio, people, websites and/or TV.

The archived communication 506 may be accessed and/or the webpage 602 associated with the archived communication 506 (e.g., the interview between the first user 102 and the second user 102 conducted through a geo-spatial social network 200 embodying the three-dimensional map view) may be generated. The archived communication 506 may be distributed according to a predetermined distribution plan. The archived communication 506 may be distributed to the media providers. The archived communication 506 may be provided via the fixed medium (e.g., CD, DVD, etc.). A fifth instruction set may provide accessibility to the archived communication 506. A sixth instruction set may distribute the archived communication 506.

FIG. 7 is a user interface view 700 of a first user profile 204 associated with a first user 102 in the integrated social-communication environment 100, according to one embodiment. Particularly, FIG. 7 illustrates a contact list 702, a my neighborhood 704, a wiki profile 706 and a communication indicator 708, according to one embodiment.

The contact list 702 may display details of contacts (e.g., friends, businesses, places, etc.) associated with the first user 102 of the integrated social-communication environment 100. The my neighborhood 704 may display in a three dimensional map, markers representing the user profiles 204 associated with the users 102 of the integrated social-communication environment 100. The wiki profile 706 may indicate a wiki profile associated with a user 102 in a neighborhood of the integrated social-communication environment 100. The communication indicator 708 may allow the first user 102 associated with the first user profile 204 to generate the communication 504 with the second user 102 associated with the second user profile 204 in the integrated social-communication environment 100.

In the example embodiment illustrated in FIG. 7, user profile view 700 shows the first user profile 204 having the contact list 702 associated with the first user 102 and the my neighborhood 704. The user profile view displays in the map, the wiki profile(s) associated with the user 102 through the my neighborhood 704. The user profile view 700 may enable the first user 102 to communicate with the second user 102 using the communication indicator 708.

The communication indicator 708 associated with the second user profile 204 may be selected (e.g., using the select module 110 of FIG. 1). The communication may be represented as a marker in the three-dimensional map view (e.g., of the integrated social-communication environment 100 of FIG. 1). Other user profiles 204 may be simultaneously represented adjacent to the marker. The marker may be placed in a location associated with the first user 102 and/or the second user 102. At least one wiki profile 706 may be generated associated with the webpage 602.

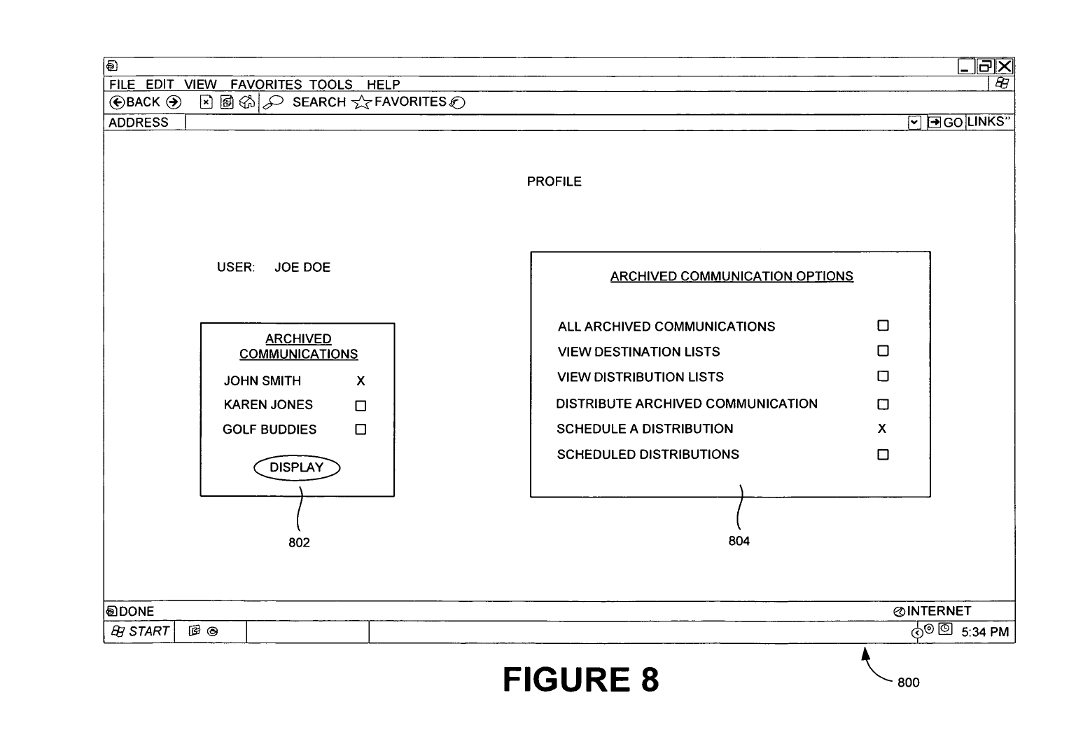

FIG. 8 is an archive options page view 800 showing archive options associated with the archived communication 506, according to one embodiment. Particularly, FIG. 8 illustrates a block 802 and archived communication options 804, according to one embodiment.

The block 802 may provide access to the archived communication 506 of the first user 102 with selected users 102 (e.g., the second user 102) in the integrated social-communication environment 100. The archived communication options 804 may provide the first user 102 associated with the first user profile 204 various distribution options (e.g., scheduled distributions, view distribution lists, etc.) available for the distribution of the archived communication 506. The archived communication options 804 may enable the users 102 to view information associated with the archived communication 506 in the integrated social-communication environment 100.

In the example embodiment illustrated in FIG. 8, the archive options page view 800 displays the archived communications of Joe Doe with John Smith through the block 802. The archive options page view 800 also enables the user 102 associated with the user profile 204 to view all archived communications, view destination lists, view distribution lists, distribute archived communications, schedule a distribution, view scheduled distributions through the archived communication options 804.

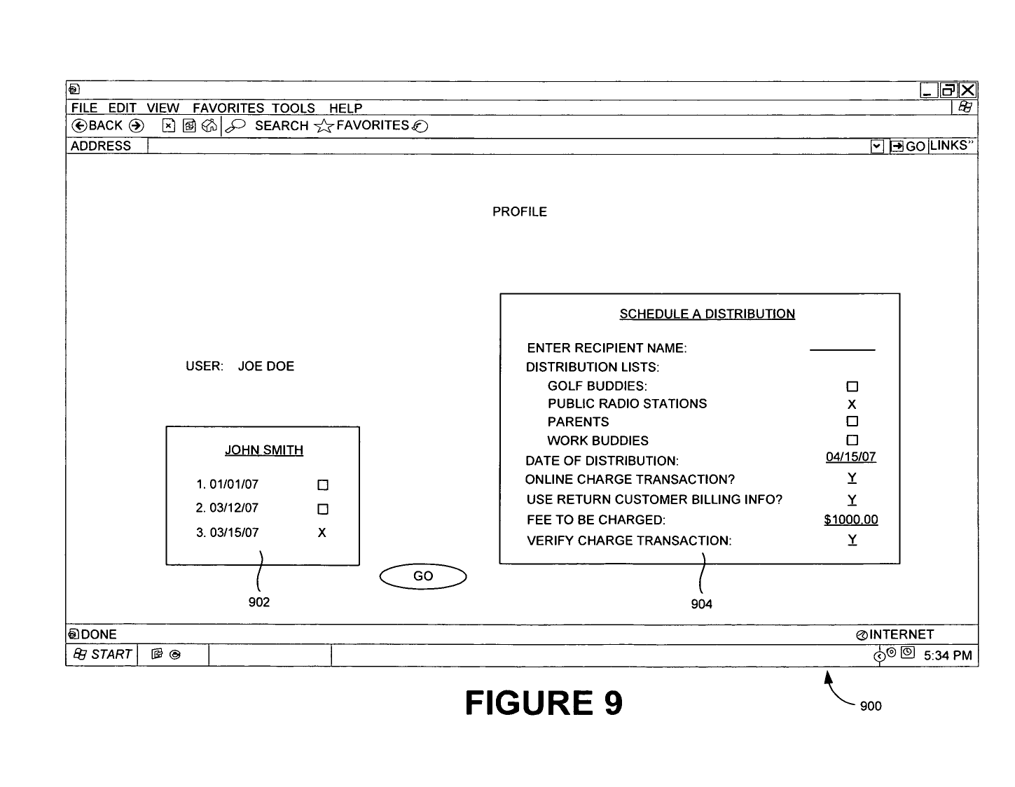

FIG. 9 is a user interface view 900 showing a schedule distribution page, according to one embodiment. Particularly, FIG. 9 illustrates a block 902 and a schedule a distribution option 904, according to one embodiment.

The block 902 may display dates associated with the archived communication 506 of the first user 102 with a particular user 102 in the contact list of the first user 102. The schedule a distribution option 904 may enable the user 102 associated with the profile (e.g., the user profile 204) to schedule distribution of the archived communication 506 to the distribution lists according to the predetermined distribution plan. In addition, the schedule the distribution option 904 may enable the user 102 to schedule a date for distribution of the archived communications, select transaction options, etc.

In the example embodiment as illustrated in FIG. 9, the user interface view 900 shows the scheduling of the distribution of the archived communication associated the first user to required destinations through the various distribution channels.

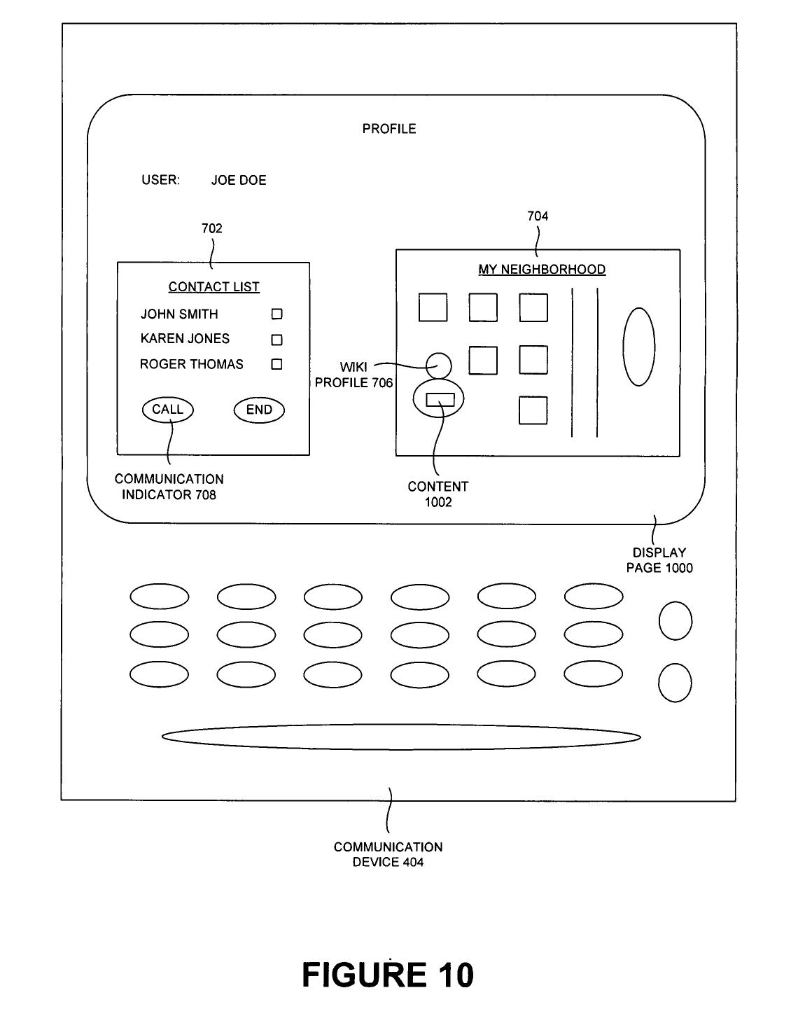

FIG. 10 is a user interface view 1000 of the communication device 404 illustrating a display page 1000, according to one embodiment. Particularly, FIG. 10 illustrates the contact list 702, the my neighborhood 704, the wiki profile 706, the communication indicator 708 and content 1002, according to one embodiment.

The communication device 404 may be the personal computer, the mobile phone, the personal digital assistant, etc. used for generating the communication 504 between the users 102 associated with the user profile 204 having the specific contact code 206. The contact list 702 may contain information associated with friends, businesses and/or places with whom the first user 102 associated with the first user profile 204 may wish to communicate through the communication indicator 708. The display page 1000 may be the webpage 602 generated in the communication device 404 which enables the first user 102 associated with the first user profile 204 to communicate with the other people in the neighborhood. The display page 1000 may also display the content 1002 associated with the wiki profile 706 generated simultaneously with the webpage 602 in the communication device 404. The content 1002 may be comments, thoughts and/or views that are appended to the wiki profile 706 associated with the user 102 (e.g., the first user 102 and/or the second user 102) of the integrated social-communication environment 100.

In the example embodiment as illustrated in FIG. 10, the communication device 404 shows the display page 1000 containing the webpage. The users 102 may communicate with any selected user 102 associated with the user profile 204 having a specific contact code 206 using the communication indicator 708 of the communication device 404. The display page 1000 displays the my neighborhood 704. In addition, the my neighborhood 704 displays the wiki profile 706 containing the content 1002 associated with the particular user 102 in the neighborhood.

The display page 1000 (e.g., includes the webpage) may be associated with the archived communication. At least one wiki profile 706 may be associated with the display page 1000. The content 1002 may be appended to the wiki profile 706.

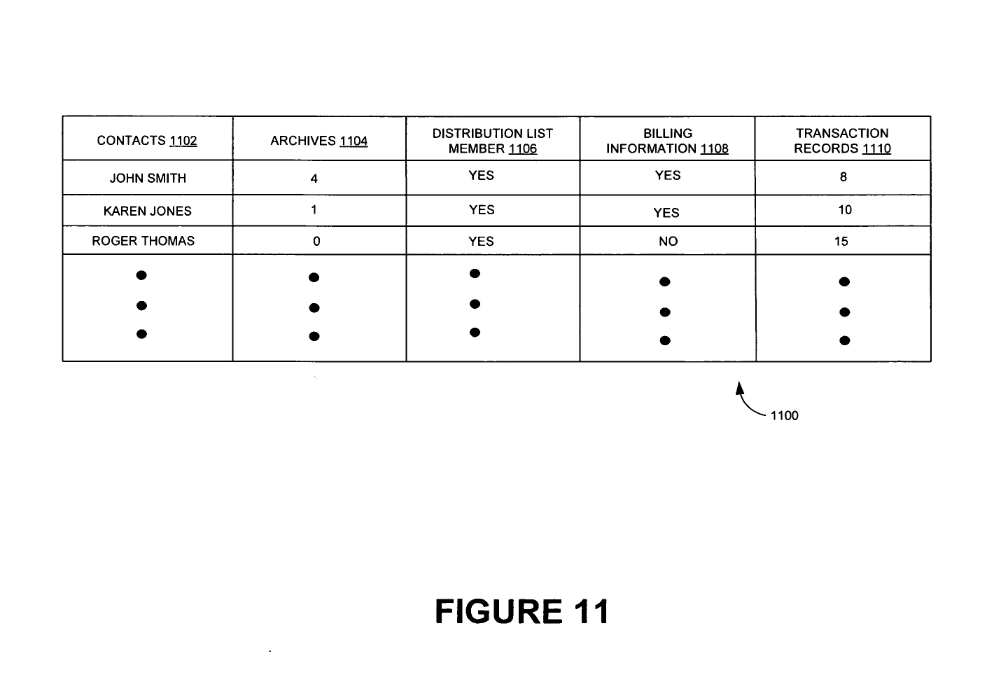

FIG. 11 is a table view 1100 displaying distribution details of an archived communication, according to one embodiment. Particularly, FIG. 11 illustrates a contacts field 1102, an archives field 1104, a distribution list member field 1106, a billing information field 1108 and a transaction records field 1110, according to one embodiment.

The contacts field 1102 may display contacts (e.g., friends, businesses and/or places) associated with a first user 102 of the archived communication 506 in the integrated social-communication environment 100. The archives field 1104 may indicate the number of archived communications associated with the users 102 (e.g., the first and second users 102) of the integrated social-communication environment 100. The distribution list member field 1106 may show whether a particular contact associated with the first user 102 (e.g., the caller) belongs to the distribution list associated with the archived communication 506. The billing information field 1108 may display whether the fee based transaction is involved in the archived communication 506 of the users 102 in the integrated social-communication environment 100. The transaction records field 1110 may show the number of fee-based transactions carried out by the user 102 for distributing the archived communication 506 in the integrated social-communication environment 100.

In the example embodiment illustrated in FIG. 11, the contacts field 1102 displays “John Smith” in the first row, “Karen Jones” in the second row and “Roger Thomas” in the third row of the contact field column 1102. The archives field 1104 displays “4” in the first row, “1” in the second row and “0” in the third row of the archives field column 1104 (e.g., John Smith has four archived communications, Karen Jones has one archived communication and Roger Thomas has no archived communications). The distribution list member field 1106 displays “Yes” in the first row, “Yes” in the second row and “Yes” in the third row of the distribution list member field column 1106 (e.g., John Smith, Karen Jones and Roger Thomas are members of the distribution list associated with the archived communication of the first user 102). The billing information field 1108 displays “Yes” in the first row, “Yes” in the second row and “No” in the third row of the billing information field column 1108 (e.g., a fee based transaction is involved in the archived communication associated with John Smith, Karen Jones and Roger Thomas). The transaction records field 1110 displays “8” in the first row, “10” in the second row and “15” in the third row of the transaction records field column 1110 (e.g., there are eight, ten, and fifteen fee based transactions associated with the archived communications of John Smith, Karen Jones and Roger Thomas).

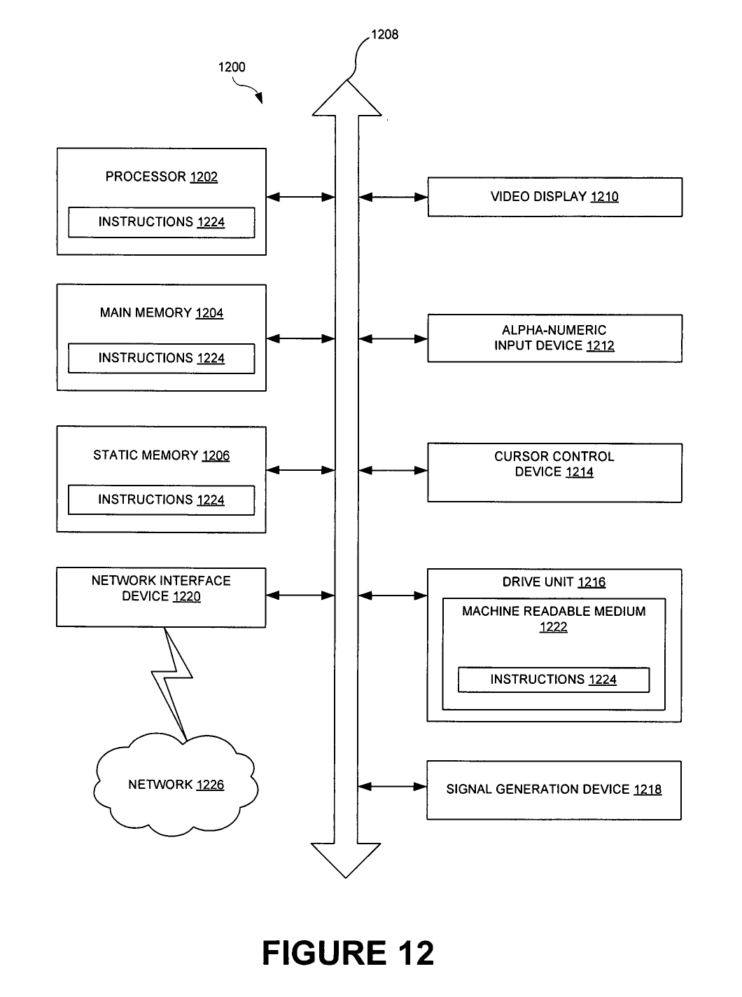

FIG. 12 is a diagrammatic system view 1200 of a data processing system in which any of the embodiments disclosed herein may be performed, according to one embodiment. Particularly, the diagrammatic system view 1200 of FIG. 12 illustrates a processor 1202, a main memory 1204, a static memory 1206, a bus 1208, a video display 1210, an alpha-numeric input device 1212, a cursor control device 1214, a drive unit 1216, a signal generation device 1218, a network interface device 1220, a machine readable medium 1222, instructions 1224, and a network 1226, according to one embodiment.

The diagrammatic system view 1200 may indicate a personal computer and the data processing system in which one or more operations disclosed herein are performed. The processor 1202 may be a microprocessor, a state machine, an application specific integrated circuit, a field programmable gate array, etc. (e.g., Intel® Pentium® processor). The main memory 1204 may be a dynamic random access memory and/or a primary memory of a computer system.

The static memory 1206 may be a hard drive, a flash drive, and/or other memory information associated with the data processing system. The bus 1208 may be an interconnection between various circuits and/or structures of the data processing system. The video display 1210 may provide graphical representation of information on the data processing system. The alpha-numeric input device 1212 may be a keypad, a keyboard and/or any other input device of text (e.g., a special device to aid the physically challenged). The cursor control device 1214 may be a pointing device such as a mouse.

The drive unit 1216 may be the hard drive, a storage system, and/or other longer term storage subsystem. The signal generation device 1218 may be a bios and/or a functional operating system of the data processing system. The network interface device 1220 may be a device that may perform interface functions such as code conversion, protocol conversion and/or buffering required for communication to and from the network 1226. The machine readable medium 1222 may provide instructions on which any of the methods disclosed herein may be performed. The instructions 1224 may provide source code and/or data code to the processor 1202 to enable any one/or more operations disclosed herein.

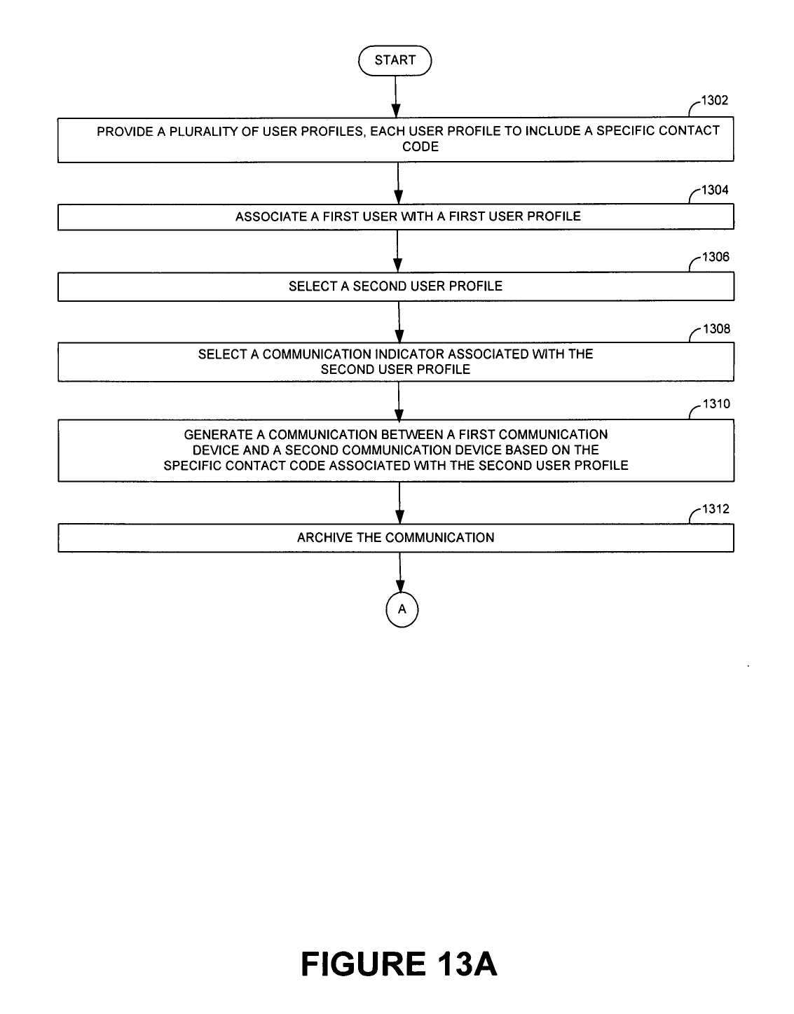

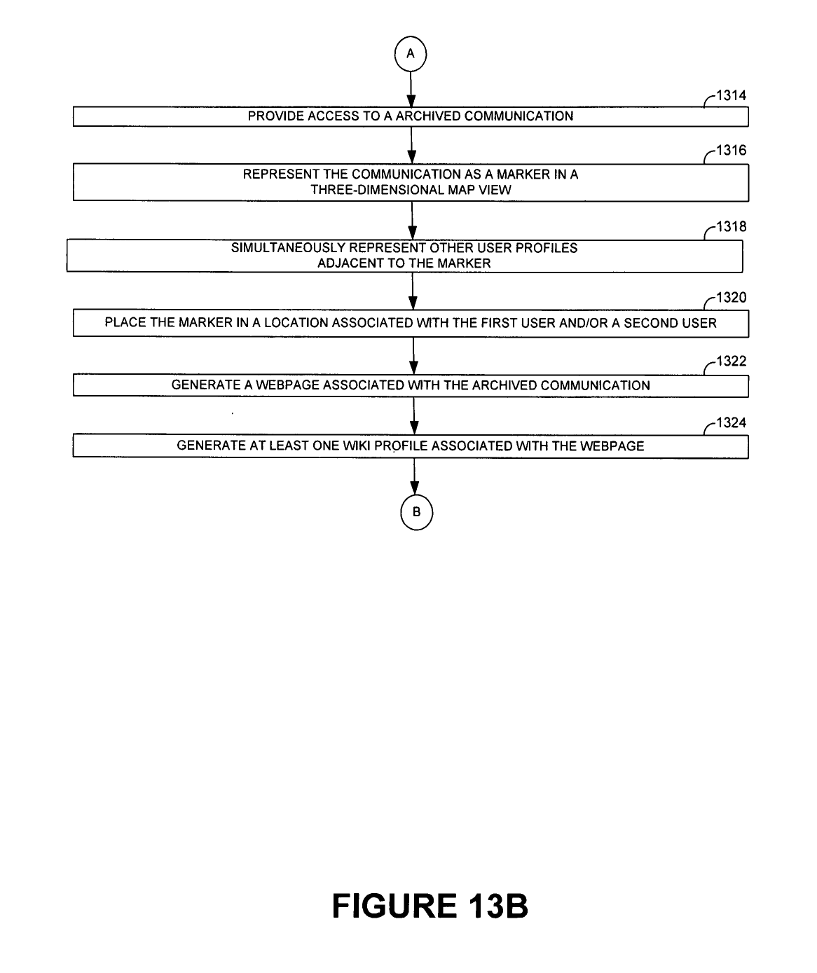

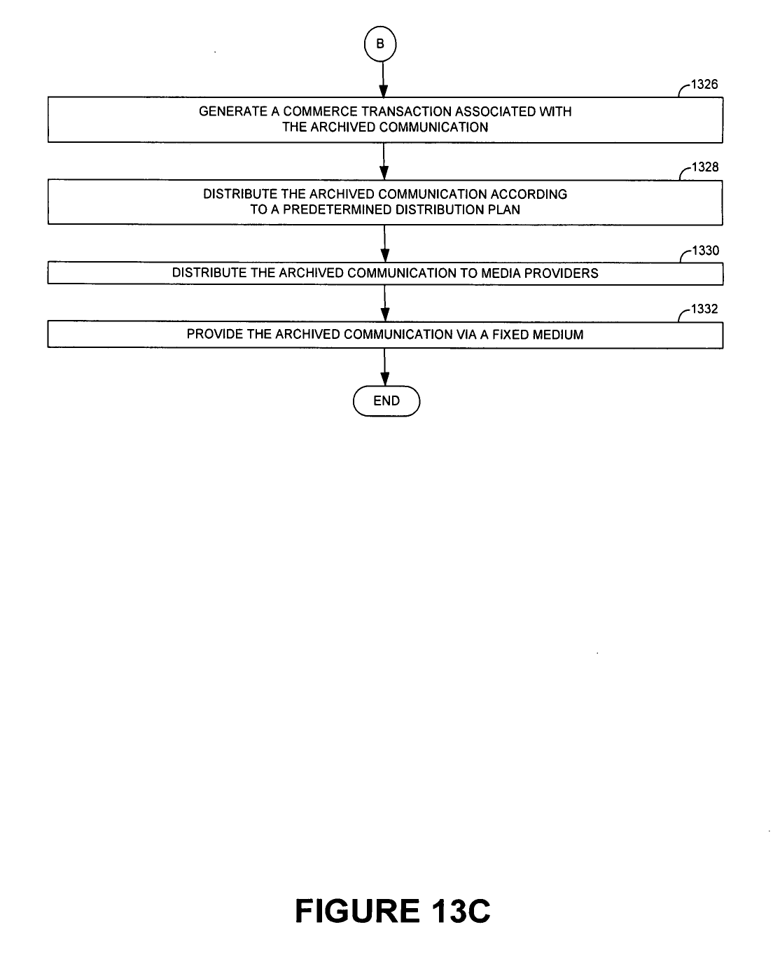

FIG. 13A is a process flow of generating and archiving a communication between a first communication device 404 and a second communication device 404, according to one embodiment. In operation 1302, a plurality of user profiles (e.g., the user profiles 204 of FIG. 2) may be provided, each user profile 204 to include a specific contact code (e.g., the specific contact code 206 of FIG. 2). In operation 1304, a first user 102 may be associated with a first user profile 204. In operation 1306, a second user profile 204 may be selected (e.g., using the select module 110 of FIG. 1). In operation 1308, a communication indicator (e.g., the communication indicator 708 of FIG. 7) associated with the second user profile 204 may be selected (e.g., using the select module 110 of FIG. 1). In operation 1310, a communication (e.g., the communication 504 of FIG. 5) between a first communication device 404 and a second communication device 404 may be generated based on the specific contact code 206 associated with the second user profile 204. In operation 1312, the communication 504 may be archived (e.g., using the archive module 114 of FIG. 1).

FIG. 13B is a continuation of the process flow of FIG. 13A, showing additional processes, according to one embodiment. In operation 1314, access may be provided to the archived communication 506 (e.g., using the additional modules 116 of FIG. 1). In operation 1316, the communication 504 may be represented as a marker in a three-dimensional map view (e.g., in a geo-spatial environment). In operation 1318, other user profiles 204 may be simultaneously represented adjacent to the marker. In operation 1320, the marker may be placed in a location associated with the first user 102 and/or the second user 102. In operation 1322, a webpage (e.g., the webpage 602 of FIG. 6) associated with the archived communication 506 may be generated (e.g., using the webpage module 304 of FIG. 3). In operation 1324, at least one wiki profile (e.g., the wiki profile 706) associated with the webpage 602 may be generated (e.g., using the wiki profile module 304A of FIG. 3).

FIG. 13C is a continuation of the process flow of FIG. 13B, showing additional processes, according to one embodiment. In operation 1326, a commerce transaction associated with the archived communication 506 may be generated (e.g., using the commerce transaction module 308 of FIG. 3). In operation 1328, the archived communication 506 may be distributed (e.g., using the distribution module 306 of FIG. 3) according to a predetermined distribution plan. In operation 1330, the archived communication 506 may be distributed to media providers (e.g., through a communication with the media module 306A of FIG. 3). In operation 1332, the archived communication 506 may be provided via a fixed medium (e.g., CD, DVD formats, etc.).

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structures and methods may be embodied using transistors, logic gates, and electrical circuits (e.g., Application Specific Integrated Circuitry (ASIC) and/or in Digital Signal Processor (DSP) circuitry).

For example, the social network module 106, the contact module 108, the select module 110, the communication module 112, the archive module 114, the additional modules 116, the publish module 302, the webpage module 304, the wiki profile module 304A, the append module 304B, the distribution module 306, the media module 306A, the commerce transaction module 308, the fee-based transaction module 308A, the download module 310 and other modules of FIGS. 1-10 may be enabled using a social network circuit, a contact circuit, a select circuit, a communication circuit, an archive circuit, additional circuits, a publish circuit, a webpage circuit, a wiki profile circuit, an append circuit, a distribution circuit, a media circuit, a commerce transaction circuit, a fee-based transaction circuit, a download circuit and other circuits using one or more of the technologies described herein.

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A method, comprising:
providing a plurality of user profiles, each user profile in the plurality of user profiles to include a specific contact code;
associating a first user with a first user profile in the plurality of user profiles;
selecting a second user profile in the plurality of user profiles;
selecting a communication indicator associated with the second user profile;
generating a communication between a first communication device and a second communication device based on the specific contact code associated with the second user profile; and
archiving the communication.

2. The method of claim 1, further comprising:
providing access to the archived communication;
representing the communication as a marker in a three-dimensional map view;
simultaneously representing other user profiles adjacent to the marker; and
placing the marker in a location associated with at least one of the first user and the second user.

3. The method of claim 2, further comprising generating a webpage associated with the archived communication, wherein the communication is at least one of an interview between the first user and the second user conducted through a geo-spatial social network embodying the three-dimensional map view.

4. The method of claim 3, further comprising generating at least one wiki profile associated with the webpage.

5. The method of claim 1, further comprising generating a commerce transaction associated with the archived communication.

6. The method of claim 1, further comprising distributing the archived communication according to a predetermined distribution plan.

7. The method of claim 6, further comprising distributing the archived communication to media providers.

8. The method of claim 1, further comprising providing the archived communication via a fixed medium.

9. The method of claim 1 in a form of a machine-readable medium embodying a set of instructions that, when executed by a machine, causes the machine to perform the method of claim 1

10. A system, comprising:
an integrated social-communication environment;
a contact module of the integrated social-communication environment, to include user profiles, each user profile of the user profiles to include a specific contact code;
a select module to select a user profile of the user profiles;
a communication module to generate a communication between a first communication device and a second communication device, wherein the communication is based on the specific contact code of the selected user profile of the user profiles; and
an archive module to archive the communication.

11. The system of claim 10, further comprising a publish module to publish the archived communication.

12. The system of claim 10, further comprising a webpage module to generate a webpage associated with the archived communication.

13. The system of claim 12, further comprising a wiki profile module to generate, with the webpage, at least one wiki profile associated with the webpage.

14. The system of claim 13, further comprising an append module to generate, with the at least one wiki profile, content associated with the at least one wiki profile.

15. The system of claim 10, further comprising a distribution module to distribute the archived communication via a distribution channel.

16. The system of claim 15, further comprising a media module to distribute the archived communication to media providers.

17. The system of claim 10, further comprising a commerce transaction module to generate a transaction associated with the archived communication.

18. The system of claim 17, further comprising a fee-based transaction module to generate a fee-based transaction associated with the archived communication.

19. The system of claim 10, further comprising a download module to provide the system on a communication device.

20. An integrated social-communication environment, comprising:
a first instruction set to enable a social network, to include a user database, the user database to include associated user profiles, the social network associated with contact data, in which the social network is associated with specific contact codes in the contact data;
a second instruction set integrated with the first instruction set to select a user profile of the user profiles, the user profile to include a specific contact code identifiable in the contact data;
a third instruction set integrated with the first instruction set and the second instruction set to generate a communication, between a first communication device associated with a first user profile in the user profiles and a second communication device associated with a selected second user profile in the user profiles, the communication path based on the specific contact code associated with the selected user profile; and
a fourth instruction set integrated with the first instruction set and the second instruction set and the third instruction set to archive the communication.

21. The integrated social-communication environment of claim 20, further comprising a fifth instruction set to provide accessibility to the archived communication.

22. The integrated social-communication environment of claim 20, further comprising a sixth instruction set to distribute the archived communication.

23. A system, comprising:
a first communication device to include:
a contact module of an integrated social-communication environment, to include user profiles, each user profile of the user profiles to include an associated specific contact code;
a select module to select a user profile of the user profiles;
a communication module, to generate a communication, between the first communication device and a second communication device associated with a selected user profile; and
an archive module to archive the communication.

24. The system of claim 23, wherein the first communication device includes at least one of a personal computer, a mobile phone, and a personal digital assistant.

25. The system of claim 24, further comprising a display page associated with the archived communication.

26. The system of claim 25, wherein the display page further comprises a webpage.

27. The system of claim 26, further comprising at least one wiki profile associated with the display page.

28. The system of claim 27, further comprising content appended to the at least one wiki profile.
